(19) United States
(12) Patent Application Publication
(10) Pub. No.: US 2004/0093348 A1
(43) Pub. Date: May 13, 2004

(54) Method for automated management and intelligent administration of compliant computers

(76) Inventor: Ovidiu Stavrica, Kenmore, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/374,702

(22) Filed: Jun. 16, 2003

Related U.S. Application Data
(60) Provisional application No. 60/358,940, filed on Feb. 22, 2002.

(51) Int. Cl. G06F 17/00

(52) U.S. Cl. 707/103 R

(57) ABSTRACT

Methods, and related apparatus and systems to automatically and intelligently administer compliant computers through the use of information (knowledge) stored in at least one database are disclosed. A knowledge database includes commands, and command links or relations, which are used to create jobs having specific operations and objectives. Each command record in the database includes a unique task ID field, at least one command, and preferably a description tag. Each record in the database includes a job ID, a parent relation and a child relation. From a sequential execution point of view, the parent/child relationship identifies the command execution sequence between a prior command (parent) and subsequent command (child). A feature of the invention is its ability to retain and possibly modify jobs based upon the success or failure of a job initiated in response to a condition. If the condition is not satisfactorily addressed, then additional commands obtained from the knowledge database may be employed or at least one existing command deleted (or a combination of the two) in an attempt to obtain a viable solution to the condition. Once successful, any new commands not previously in the database are retained, and the algorithm for command structure (link structure) retained for future use should the same or similar solution be needed in the future.

Priority to co-pending U.S. patent application No. 60/358,940 is hereby claimed, and the disclosure therein incorporated by reference herein.

### FIELD OF INVENTION

The invention relates to the management and deployment of heuristic expert systems responsible for administration of remotely adminstratable (compliant) servers and workstation.

### DESCRIPTION OF PRIOR ART AND RELATED WORKS

A number of rudimentary Unix compliant utilities are available that enable a remote administrator to run commands and scripts on remote server or workstation machines. Typically, these utilities will either upload a script file to the remote machine and execute that script or, process a script file on the local administrator's machine and execute the commands one at a time through a thin-client virtual terminal connection such as rlogin, telnet, or ssh.

Advanced management systems, such as PIKT and Cfengine, utilize specific script programming languages to test for conditions and determine what commands need to be executed or what alarms need to be raised. A rudimentary intelligence becomes available through the “if-then” structure inherent in more advanced scripts of such management systems that elevate them to the functionality of primitive expert systems.

### SUMMARY OF INVENTION

The invention is directed to methods, and related apparatus and systems that automatically and intelligently administer, e.g., monitor, diagnose, manage, upgrade and/or repair, remote compliant computers such as servers and workstations through the use of information (knowledge) stored in at least one database. A compliant computer is defined as one that permits a remote administrator or user to monitor, diagnose, manage, upgrade and/or repair, the computer. The apparatus and systems of the invention thus provides a computerized expert system that administers remote compliant machines, preferably such as Unix and other Posix-based computers, through universally available thin-client apparatus that is inherently available on all compliant operating systems, regardless of communication protocols. The invention comprises several related components or modules necessary to carry out the administrative functions of monitoring, diagnosing, managing, upgrading and/or repairing, including the individual tasks of knowledge entry, knowledge storage, decision processing, remote network access, and user interfaces.

A knowledge entry component and a knowledge database component enable the expert system to be expanded in a heuristic fashion similar to the learning process of the human mind. This similarity yields an intuitive process by which needed knowledge is identified and entered into the database. In consequence, the database is functional with even a minimal knowledge set while the course of everyday operation allows for efficient addition of necessary and anticipated knowledge.

The knowledge database comprises commands, and command links or relations, which are used to create jobs having specific operations and objectives. The composition of any job may be initially determined by the relations or links aspect of the database. Preferably, the commands are stored in a first table while the relations or links between commands are stored in a second table. Each record in the first table comprises a unique task ID field, at least one command, and preferably a description tag, e.g., “fix mail server”. The first table is initially populated with at least one record, and preferably a plurality of records. Preferably, each record in the second table comprises a job ID, a parent relation and a child relation. From a sequential execution point of view, the parent/child relationship identifies the command execution sequence between a prior command (parent) and subsequent command (child).

As briefly described above, a job is defined as a procedure that, when executed by a compliant computer, is intended to solve a specific problem or achieve a certain goal. For example, a job may comprise a series of commands that safely close all open applications and reboots the compliant computer, or causes the compliant computer to execute a file transfer provided by a remote server (note that a “command” itself may also be a job, i.e., a plurality of linked commands). Thus, a job comprises at least one command, and preferably a plurality of commands, that are sequentially executed much in the same way as a shell script file executes a plurality of sequentially ordered commands. However, unlike prior art static shell scripts, a job as defined herein is dynamic, adaptable and portable as will hereinafter be described.

A feature of the invention is its ability to retain and possibly modify jobs based upon the success or failure of a job initiated in response to a condition. Thus, if the administrative computer is alerted that a compliant computer has a condition for which intervention is needed, it can issue a job in response thereto that is intended to address the identified condition. If the condition is satisfactorily addressed, then no further action is needed. However, if the condition is not satisfactorily addressed, then additional commands obtained from the knowledge database may be employed or at least one existing command deleted (or a combination of the two) in an attempt to obtain a viable solution to the condition. Once successful, any new commands not previously in the database are retained, and the algorithm for command structure (link structure) retained for future use should the same or similar solution be needed in the future.

The back-end user interface, which may or may not be separate software from the knowledge database, preferably permits the administrator to visualize command strings that comprise the job under consideration, or the interactions between a plurality of command strings and/or jobs. Preferably, each command (or command strings) is graphically represented as a discrete object linked to other objects in a geographically relevant scheme. New commands and/or jobs can be entered as well as old commands and/or jobs modified. Thus, the administrator may both create new commands as well as establish new command links to define new jobs, or modify existing command links that comprise a job. All linkages are stored and preferably stored in the second table.

In a robust embodiment, each record in the knowledge database comprises a task ID field, a description tag field and an executable command field, which comprises at least one command. Each command/record comprising a job is then shown in a graphic user interface (GUI) linked to at least one other command/record, wherein the linkages result from application of the relations established by the database's relational-links portion. In this manner, an administrator can see both the command/record and the sequencing of the command description tags in a relevant form for any particular job. Moreover, links between existing commands/records and/or new commands/records can be moved, removed and/or created as desired by the administrator. Thus, if an original job consisted of executing commands/records “A”, “B”, “C” and “D”, and such a job failed to address the existing condition, the administrator may create a new command/record “E” and link it to “B” and “C”. The resulting command/record execution sequence would then be “A”, “B”, “E”, “C” and “D”. If successful, the new link sequence would be saved for future application against the same or similar condition, presuming that the same or a similar failure condition is encountered.

As noted in the previous paragraph, command linking is preferably carried out via a GUI. By using a visual form of programming that more closely mimics the process of human problem solving, an administrator can build solutions without being limited to command structure knowledge. Moreover, provisions exist for intelligent substitution wherein if a job fails, the point of failure (if known) can be autonomously replaced or appended by at least one command that has a similar run condition, e.g., the command sequence “A”, “B”, “C” and “D” results in a failure returning a given exit status or return text when executing command “C” whereupon the administrative computer looks for other commands/records having the same exit status or return text to the failure, and reruns the job with command “M” in place thereof, wherein command/record “M” is associated with addressing the given exit status or return text.

The database component and related database search engine are responsible for interfacing with the knowledge entry module and passing the commands and/or jobs to the compliant computer's operating system for execution. In a preferred embodiment, the database component and the engine reside on a computer physically discrete from the compliant computer. Thus, the engine transfers the commands by passing them via a suitable bi-directional communications protocol, such as telnet or SSH, to an open port on the compliant computer. Moreover, the engine also receives command failure codes (exit statuses or return texts) from the compliant computer via a similar communication protocol. As a consequence of this relationship, when a compliant computer generates a failure code, that code is either transmitted to the monitored port in real time or upon prompting, where after the administrative computer assesses the failure code and applies at least one alternate job or branch to address the condition, if such a job or branch exists. If no alternate job or branch exists, an alert is issued for administrator intervention wherein a solution is created and applied.

A sample scenario involving a simple implementation of a preferred embodiment of the invention will now be presented. It is presumed that software embodying the invention is operationally installed on both an administrative computer and a compliant computer, and that both computers have suitable communications hardware and software so as to establish an operational SSH or telnet data link between each other. The knowledge database is initially populated with a plurality of simple job sequences to be executed on a remote compliant computer. The job sequences are initially comparable to Unix shell scripts or DOS batch files containing a number of shell commands, including but not limited to “if-then” conditionals and other script invocations. A network connection is established with the compliant computer to permit bidirectional communication with the remote administrator. Upon receipt of a command failure, a decision-processing module in the software embodying the invention then transmits selected job sequences from the knowledge database to the compliant computer for execution. The response by the compliant computer is tested for each executed command in a sequence to determine success or failure of that command.

As job sequences are executed on the remote compliant computer during normal operations, a command may eventually fail due an unexpected remote compliant computer state. Differences in state may include, but are not limited to, hardware variations, software configuration variations, and operational environment variations. When a command failure is detected during a job sequence execution, the decision-processing module searches for an alternate branch in the current job execution sequence at the current command step that matches the recognized failure mode. If a suitable branch is found, it is executed. Such branches typically return the execution pointer back to the very next command in the originating job sequence to facilitate the original sequence completion.

In the event that a suitable branch is not found, the administrator is notified and provided with the relevant information for that job sequence failure. Such information preferably includes the job sequence being processed, the point of failure, the available branches at that point of failure, and the previous execution results and audit trail for the job sequence. The administrator then gains access to the compliant computer, for example through rlogin, telnet or ssh, and manually carries out the necessary steps (missing branch) to enable the job sequence to resume from where it left off. The administrator then enters the steps that were manually carried out into the knowledge database as a branch from the command the failed. In this fashion, new knowledge is entered when a failure occurs during a specific job sequence in order to avoid that type of failure in the future.

### BRIEF DESCRIPTION OF DRAWINGS

FIG. 1 illustrates a job sequence with no branches;

FIG. 2 illustrates a job sequence with one branch off the first command;

FIG. 3 illustrates a job sequence with two branches off the first command;

FIG. 4 illustrates a job sequence with two branches off the first command and one sub-branch off one of the branches;

FIG. 5 illustrates a job sequence with two branches off the first command, one sub-branch off one of the branches and another sub-branch off one of the branches, which bypasses commands on its parent branch;

FIG. 6 illustrates a job sequence with two branches off the first command, one sub-branch off one of the branches and another sub-branch off one of the branches which bypasses commands on its parent branch as well as a branch off the third command;

FIG. 7 is a network diagram depicting the expert system, an end user personal computer, and a remote Posix compliant client computer;

FIG. 8 is a process flow chart representing the logic implemented by the decision-processing module as it proceeds through a job sequence;

FIG. 9 is a depiction of the database command records as illustrated in FIG. 1 as stored in a SQL database table;

FIG. 10 is a depiction of the database link records that maintain the relationships between the commands illustrated in FIG. 1 as stored in a SQL database table;

FIG. 11 is a depiction of the database command records as illustrated in FIG. 2 as stored in a SQL database table;

FIG. 12 is a depiction of the database link records that maintain the relationships between the commands illustrated in FIG. 2 as stored in a SQL database table;

FIG. 13 is a depiction of the database command records as illustrated in FIG. 6 as stored in a SQL database table; and

FIG. 14 is a depiction of the database link records that maintain the relationships between the commands illustrated in FIG. 6 as stored in a SQL database table.

Appendix A represents a development protocol based upon the present invention.

### DETAILED DESCRIPTION

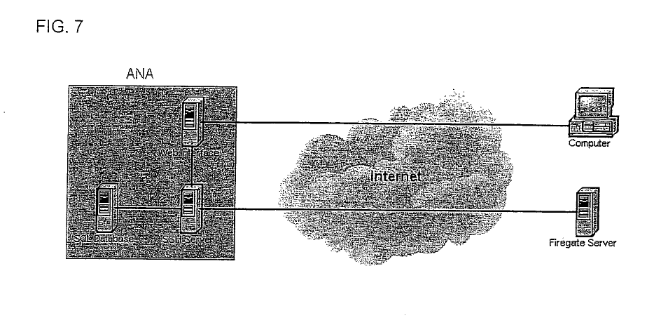

The expert system of the invention is comprised of three components: a decision-processing module, a knowledge database module and an end-user interface. These primary components may all function on a single server, or may be distributed among multiple servers communicating through a computer network, as shown in FIG. 7. In the described embodiment, the knowledge database is a Structured Query Language (SQL) database server, though the database can be any feasible database architecture; the end-user interface is a Common Gateway Interface (CGI) program, though the end-user interface is not limited to the CGI architecture; the decision-processing module is preferably comprised of one or more binary or other software executable entities running on one or more individual computer servers. In the described embodiments, the remote compliant computer is operatively running a Posix-compliant operating system.

Decision-Processing Module

The decision-processing module, which comprises a SQL search engine, is responsible for establishing the network connection to the remote compliant computer and performing the link evaluation routines. Network communication with the remote computer is typically achieved via a TCP/IP Internet connection utilizing the rlogin, telnet, or secure shell protocol. Note, however, that any TCP/IP protocol (or any network communications protocol) can be utilized to communicate with the remote compliant computer. Once the decision-processing module has an established connection to the remote computer, it accesses the knowledge database and extracts a job sequence from the database. It then executes the commands in proper order from the extracted sequence, checking the specific response condition of each executed command.

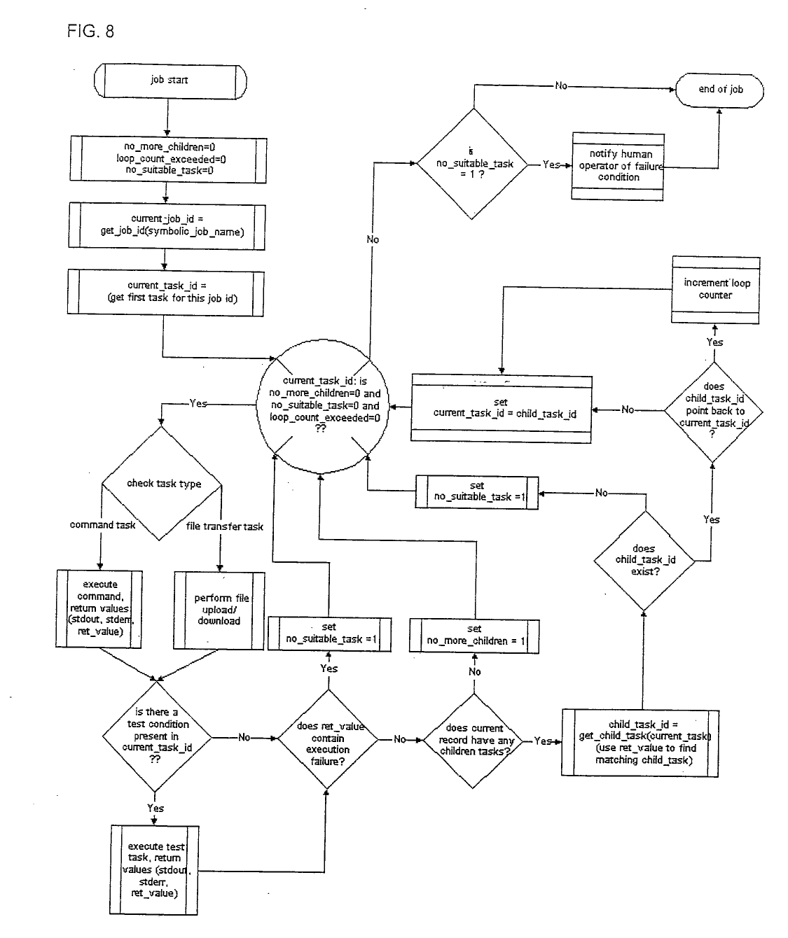

FIG. 8 illustrates the logic of the decision-processing module from the point where the TCP/IP communications is authenticated with the remote compliant computer to the point where the decision-processing module is ready to terminate the TCP/IP connection. The decision-processing module implements a repeating loop to progress through the commands within the job sequence until one of three conditions is found: a) no more children; b) no suitable task; or c) loop count exceeded. If a “no more children” event is detected, the loop terminates on the assumption that the job sequence was successfully completed. If a “no suitable task” event is detected, the loop terminates and requests assistance from a human operator. If a “loop count exceeded” event is detected, again, the loop terminates and a human operator is notified to a potential logic error within the knowledge database.

Process: Before the loop begins in FIG. 8, the three loop exit variables are set to 0. The JOB ID is obtained and used to obtain the first TASK ID. An if-then conditional verifies that the three loop exit variables are 0. The task type is checked. If it is a file transfer task, the appropriate file is sent to or retrieved from the remote computer; otherwise, it is the task is sent to the remote computer and executed. Each executed command returns information that is placed into three variables: “stdout”, “stderr”, and “ret_value”. The contents of these variables are used to determine the specific response, success, or failure of the executed command.

If the task record contains a test_condition, the test is executed on the remote computer. The test results are placed into the three variables, overwriting any information returned by the previously executed command. These three variables are inspected to detect a failure condition from the executed command or test. If a failure condition is detected, the variable “no_suitable_task” is set to “1” and the loop terminates, informing a human operator of the failure condition. If a failure condition is not detected, the knowledge database is queried to determine if the current task has any children tasks. If no more children tasks are found, the loop terminates on the assumption that the job is complete. If one or more children tasks are found, the state of the three variables, “stdout”, “stderr” and “ret_value”, are used to determine which, if any, of the children tasks should be executed next.

The child selection determination process consists of a simple SQL pattern-matching request, exemplified as:

select TASK.task_id from LINK left join TASK on LINK.child=TASK.task_id where LINKjob_id=current_job_id and LINK.parent=current_task_id and TASK.run_condition=stdout

The variable “stdout” is one of the three variables populated by the executed command or test. The variable “current_job_id” contains the identification number of the current job being executed. The variable “current_task_id” contains the identification number of the task just completed.

If the child selection process does not return a child matching the requested criteria, the variable “no_suitable_task” is set to “1” and the loop terminates, informing a human operator of the failure condition. Otherwise, the loop continues and checks to see if the “task_id” of the matching child has the same value as the current_task_id, incrementing a loop counter if the values are equal. The value in current_task_id is replaced with the “task_id” of the matching child, and the loop cycle repeats again as illustrated in FIG. 8.

Knowledge Database Metastructure

A sequence with five commands will be used as an example. Each command is executed in order from 1 to 5 as shown in FIG. 1. When a new job sequence is added to the SQL database, the job sequence contains no branches. As such there is no functional difference between an initially added job sequence in the SQL database and a plain Unix shell script or DOS batch file.

If, upon a normal job sequence execution, the decision-processing module detects a failure, unique or unexpected return condition from the remote computer after the execution of a command, it searches for branches off the command that match the detected return condition. For example, given that a failure occurs at command 1 in FIG. 1, the decision-processing module will search for a branch that matches the detected failure type. Since there are no branches in FIG. 1, a human operator is asked to intervene and resolve the failure condition in order to allow the job sequence to proceed with the next command.

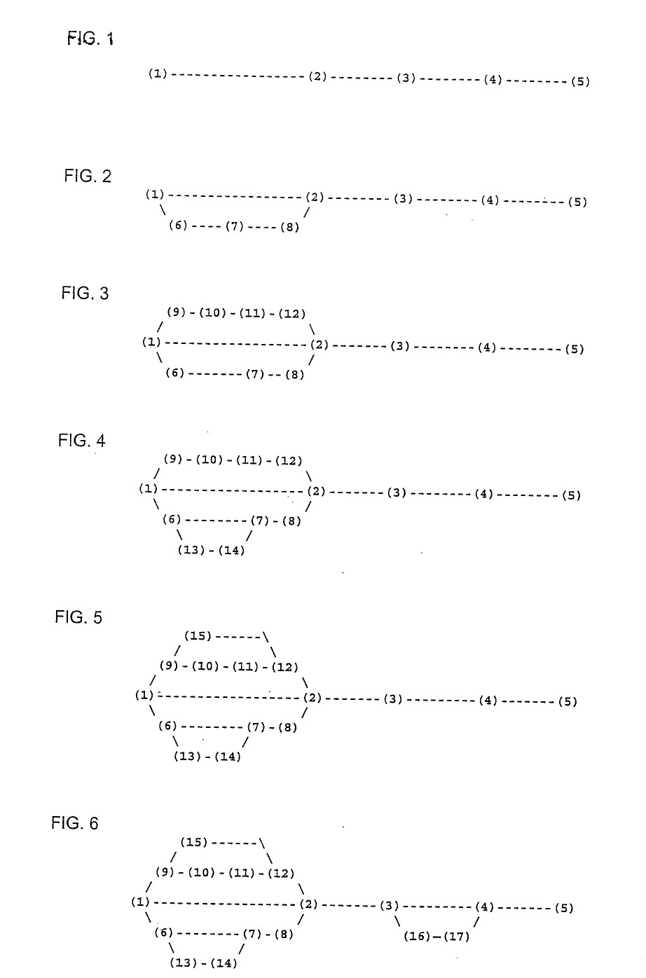

A human operator manually implements the necessary commands on the remote computer and then instructs the decision-processing module to resume the job sequence execution. Then, the human operator accesses the job sequence stored in the SQL database, as depicted in FIG. 1, and manually adds a specific branch tailored to the previously detected failure containing three commands labeled (6), (7), and (8) as represented in FIG. 2. As a result, if another remote computer returns the same failure on command (1) when executing this particular job sequence, the decision-processing module is able to intelligently respond to the failure by executing the commands (6), (7), and (8) in the branch from command (1) before proceeding to command (2), as depicted in FIG. 2. This is accomplished by including the specified failure in the “Run_condition” field for the task, thereby allowing the SQL search engine to search for all tasks matching the failure. Consequently, if command (1) is again run by the remote computer and returns a failure, the search engine will search for tasks wherein the failure matches the “Run_condition” value, and continue with that command until another failure is reached or until the task is complete.

If, during the normal sequence processing on remote computers, another unidentified response is received from the execution of command (1) in FIG. 2, the same process is repeated, potentially yielding a resulting job sequences containing a second branch with four additional commands off command (1) as illustrated in FIG. 3. At this point, when command (1) is executed in FIG. 3, the decision-processing module is able to detect among 4 different results, which enable it to proceed to command (2), command (6), command (9), or notify a human operator if the command result from the remote computer is not recognized.

While only two branches off command (1) are illustrated in FIG. 3, there can be an unlimited number of branches off each command in the job sequence. As well, each command within a branch may contain one or more sub-branches, as shown in FIG. 4 where command (6) contains a branch with commands (13) and (14). Furthermore, each sub-branch does not have to terminate in the originating branch, but can terminate in any parent branch or sequence of the originating branch and may bypass commands in a parent branch or sequence as illustrated by the command (15) branch in FIG. 5.

Knowledge Database Structure

Two tables, TASK and LINK, are required to exist in the SQL database to facilitate the operation described in the described embodiment. The TASK table stores all task-related information for all tasks in all jobs while the LINK table stores all the information used to link tasks together in order to form the job sequence structures illustrated in FIG. 1-FIG. 6. Further information relating to the structure and utilization of the knowledge database is found in the Appendix, which forms part of the specification.

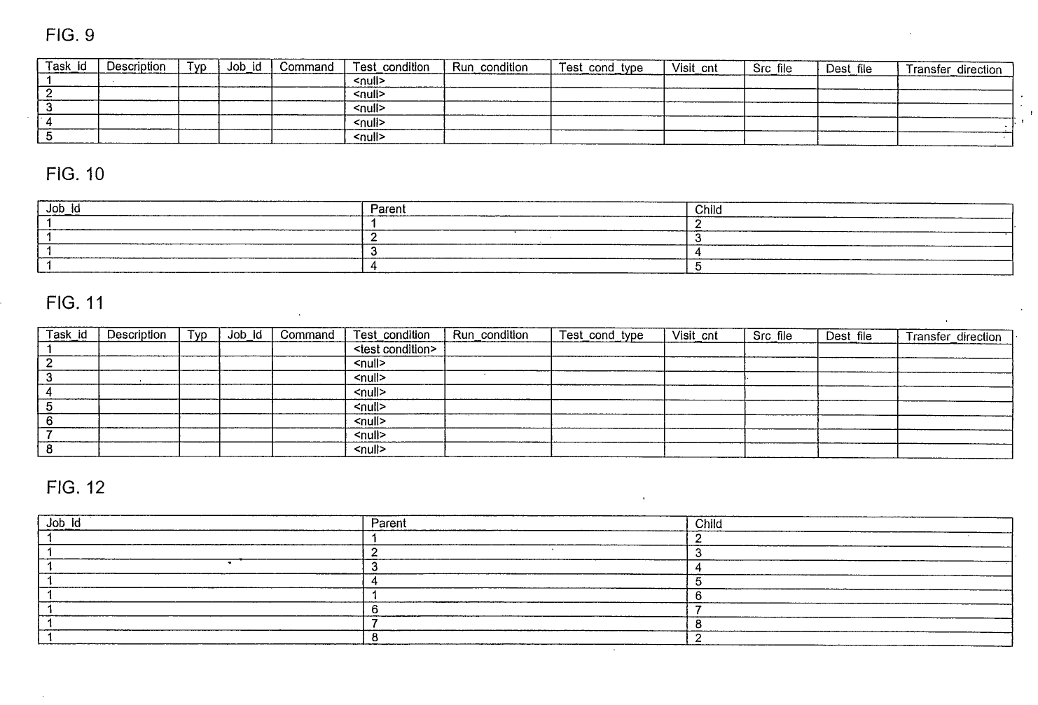

FIG. 9 and FIG. 10 provide a simple example of the relevant link information that is stored in the TASK table and LINK table respectively to represent the job sequence structure illustrated in FIG. 1. The “test_condition” field in all the records in the TASK table contains no value, thereby set to null. A null value in the “test_condition” for a record specifies that that record contains only one child and does not spawn any job execution branches. As such, each record in the LINK table in FIG. 10 specifies a unique parent, with no two records specifying the same parent.

FIGS. 11 and 12 provide a simple example of the relevant link information that is stored in the TASK table and LINK table respectively to represent the job sequence structure illustrated in FIG. 2. Because there is one branch in FIG. 2, there are two records in the LINK table in FIG. 12 that share the same parent. There are also two records that share the same child.

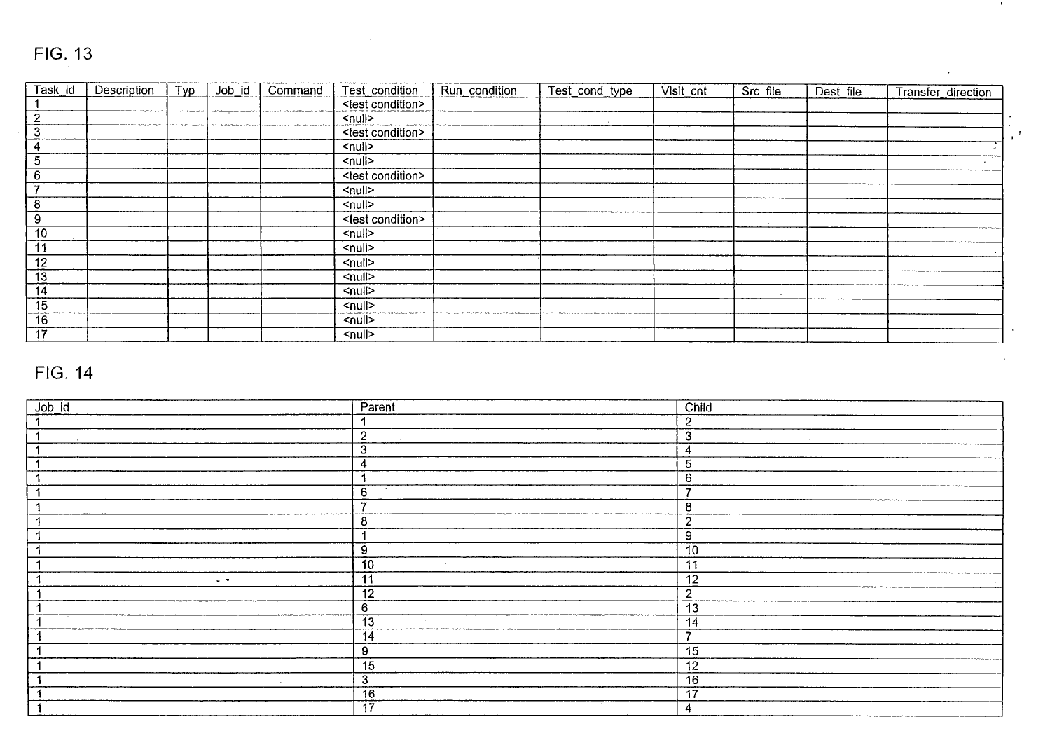

Finally, FIG. 13 and FIG. 14 provide a simple example of the relevant link information that is stored in the TASK table and LINK table respectively to represent the job sequence structure illustrated in FIG. 6. The order of records in the TASK and LINK tables is not important.

The aforementioned process for organizing knowledge in a database, automated access to the knowledge database, and human intervention notification and update protocols enable this expert system to contain an unlimited number of arbitrarily complex job sequences for implementing tasks on remote machines.

Tasks may be automatically processed for selected lists of remote client machines to provide automated monitoring and maintenance services. Tasks may also be specifically requested by client administrators through the end-user interface.

The foregoing description of an embodiment of the invention is intended to provide sufficient disclosure to enable a person of ordinary skill in the computer arts to make and use the claimed invention.

What is claimed:

1. A method for remotely managing a compliant computer from an administration computer comprising:
a) establishing a data communication link between the compliant computer and the administration computer;
b) providing a first executable command (Cₙ) to the compliant computer wherein the command (Cₙ) is selected from a plurality of executable commands (Cₓ) in a knowledge database accessible by the administration computer;
c) receiving a first response (Rₙ) by the compliant computer to its execution of the command (Cₙ);
d) if the first response (Rₙ) does not fail, then providing a subsequent executable command (Cₙ₊₁) to the compliant computer wherein the subsequent executable command (Cₙ₊₁) is selected from the plurality of executable commands (Cₓ) in the knowledge database; and
e) if the first response (Rₙ) fails, then executing an alert operation to inform an operator of the failure of the most recently provided executable command and requesting operator intervention.
